(19) United States
(12) Patent Application Publication
(10) Pub. No.: US 2025/0197164 A1
(43) Pub. Date: Jun. 19, 2025

(54) METHOD AND AN APPARATUS FOR EVALUATING A CONFIGURATION ASSOCIATED WITH AN ELEVATOR

(71) Applicant: KONE Corporation, Helsinki (FI)

(72) Inventor: Ferenc Staengler, Helsinki (FI)

(73) Assignee: KONE Corporation, Helsinki (FI)

(21) Appl. No.: 19/070,979

(22) Filed: Mar. 5, 2025

Related U.S. Application Data
(63) Continuation of application No. PCT/EP2022/079613, filed on Oct. 24, 2022.

(51) Int. Cl. B66B 1/34

(52) U.S. Cl. CPC B66B 1/3423; B66B 1/3453

(57) ABSTRACT

According to an aspect, there is provided a solution for evaluating a configuration associated with an elevator. An update request may be received for a new configuration to be deployed with the elevator. It may be checked, from a memory, whether the new configuration exists in the memory. When the new configuration does not exist in the memory, a request for performing configuration upgrade tests associated with the elevator may be issued. The request causes a testing environment to obtain information associated with a first testing procedure using a software package associated with an existing configuration used in the elevator and to obtain information associated with a second testing procedure using a software package associated with the new configuration to be deployed with the elevator. A diagnostic report associated with the first and second testing procedures may be received and stored in the memory. The data stored in the memory may be evaluated to generate at least one prediction associated with the new configuration, and the at least one prediction may be sent in response to the update request.

### BACKGROUND

In an elevator system there is a large amount of elements and components that operate based on their associated software. Different floors in the elevator system may have different elements and components. This leads to a situation that the software associated with the elements and components may be updated over the time in a different pace. Additionally, some elements or components may be updated or replaced over the time. This in turn leads to a situation in which the number of various combinations of hardware and software in use in different elevator sites is huge.

When software and/or hardware is updated, this typically requires on-site visits by maintenance personnel. Further, when performing the update, it has to be ensured that the elevator still operates correctly after the update.

Thus, one challenge in modern elevator systems is the combination of different updatable elements and components. This may lead, for example, to a situation in which a new software version of an element or component is no longer fully compatible with the element or component itself, and the element or component may not necessarily operate correctly after the software update.

### SUMMARY

According to a first aspect, there is provided a method for evaluating a configuration associated with an elevator. The method comprises receiving an update request for a new configuration to be deployed with the elevator; checking, from a memory, whether the new configuration exists in the memory; when the new configuration does not exist in the memory, issuing a request for performing configuration upgrade tests associated with the elevator, the request causing a testing environment to obtain information associated with a first testing procedure using a software package associated with an existing configuration used in the elevator and information associated with a second testing procedure using a software package associated with the new configuration to be deployed with the elevator; receiving a diagnostic report associated with the first and second testing procedures; storing the diagnostic report in the memory; evaluating the data stored in the memory to generate at least one prediction associated with the new configuration; and sending the at least one prediction in response to the update request.

In an implementation form of the first aspect, the method further comprises evaluating the data stored in the memory to generate the at least one prediction associated with the new configuration by applying machine learning.

In an implementation form of the first aspect, the at least one prediction comprises at least one of a predicted success rate associated with the new configuration and risks associated with the new configuration.

In an implementation form of the first aspect, the diagnostic report comprises test data associated with a sub-configuration of the existing configuration and a sub-configuration of the new configuration, and the method further comprises generating the at least one prediction at least in part based on the test data associated with a sub-configuration of the existing configuration and a sub-configuration of the new configuration.

In an implementation form of the first aspect, the testing environment comprises s a software testing environment and/or a hardware testing environment.

In an implementation form of the first aspect, the testing environment comprises a combination of a software testing environment and a hardware testing environment.

In an implementation form of the first aspect, the testing environment comprises a hardware testing environment.

According to a second aspect, there is provided a method for testing a configuration associated with an elevator. The method comprises receiving a request for configuration upgrade tests associated with the elevator; obtaining information associated with a first testing procedure using a software package associated with an existing configuration used in the elevator; obtaining a software package for a new configuration to be deployed with the elevator; configuring equipment associated with a testing environment according to the new configuration; performing a second testing procedure by testing the testing environment with the software package associated with the new configuration to provide information associated with the second testing procedure; creating a diagnostics report based on the information associated with the first testing procedure and the second testing procedure; and sending the diagnostic report in response to the request.

In an implementation form of the second aspect, obtaining information associated with a first testing procedure using a software package associated with an existing configuration used in the elevator comprises obtaining a software package for the existing configuration used with the elevator; configuring the equipment associated with the testing environment according to the existing configuration; and performing the first testing procedure by testing the testing environment with the software package associated with the existing configuration to provide information associated with the first testing procedure.

In an implementation form of the second aspect, obtaining information associated with a first testing procedure using a software package associated with an existing configuration used in the elevator comprises obtaining the information associated with the first testing procedure from a memory.

In an implementation form of the second aspect, configuring equipment associated with a testing environment according to the existing configuration comprises configuring the equipment associated with the testing environment according to a sub-configuration of the existing configuration.

In an implementation form of the second aspect, configuring equipment associated with a testing environment according to the new configuration comprises configuring the equipment associated with the testing environment according to a sub-configuration of the new configuration.

In an implementation form of the second aspect, the testing environment comprises a software testing environment and/or a hardware testing environment.

In an implementation form of the second aspect, the testing environment comprises a combination of a software testing environment and a hardware testing environment.

In an implementation form of the first aspect, the testing environment comprises a hardware testing environment.

According to a third aspect, there is provided an apparatus for evaluating a configuration associated with an elevator. The apparatus comprises means for receiving an update request for a new configuration to be deployed with the elevator; means for checking, from a memory, whether the new configuration exists in the memory; means for issuing a request for performing configuration upgrade tests associated with the elevator, when the new configuration does not exist in the memory, the request causing a testing environment to obtain information associated with a first testing procedure using a software package associated with an existing configuration used in the elevator and information associated with a second testing procedure using a software package associated with the new configuration to be deployed with the elevator; means for receiving a diagnostic report associated with the first and second testing procedures; means for storing the diagnostic report; means for evaluating the stored data to generate at least one prediction associated with the new configuration; and means for sending the at least one prediction in response to the update request.

In an implementation form of the third aspect, the apparatus further comprises means for evaluating the data stored in the memory to generate the at least one prediction associated with the new configuration by applying machine learning.

In an implementation form of the third aspect, the at least one prediction comprises at least one of a predicted success rate associated with the new configuration and risks associated with the new configuration.

In an implementation form of the third aspect, the diagnostic report comprises test data associated with a sub-configuration of the existing configuration and a sub-configuration of the new configuration, and the apparatus further comprises means for generating the at least one prediction at least in part based on the test data associated with a sub-configuration of the existing configuration and a sub-configuration of the new configuration.

In an implementation form of the third aspect, the testing environment comprises a software testing environment and/or a hardware testing environment.

According to a fourth aspect, there is provided a system for testing a configuration associated with an elevator. The system comprises means for receiving a request for configuration upgrade tests associated with the elevator; means for obtaining information associated with a first testing procedure using a software package associated with an existing configuration used in the elevator; means for obtaining a software package for a new configuration to be deployed with the elevator; means for configuring equipment associated with a testing environment according to the new configuration; means for performing a second testing procedure by testing the testing environment with the software package associated with the new configuration to provide information associated with the second testing procedure; means for creating a diagnostics report based on the information associated with the first testing procedure and the second testing procedure; and means for sending the diagnostic report in response to the request.

In an implementation form of the fourth aspect, the means for obtaining information associated with a first testing procedure using a software package associated with an existing configuration used in the elevator are configured to obtain a software package for the existing configuration used with the elevator; configure the equipment associated with the testing environment according to the existing configuration; and perform the first testing procedure by testing the testing environment with the software package associated with the existing configuration to provide information associated with the first testing procedure.

In an implementation form of the fourth aspect, the means for obtaining information associated with a first testing procedure using a software package associated with an existing configuration used in the elevator are configured to obtain the information associated with the first testing procedure from a memory.

In an implementation form of the fourth aspect, the means for configuring are configured to configure the equipment associated with the testing environment according to a sub-configuration of the existing configuration.

In an implementation form of the fourth aspect, the means for configuring are configured to configure the equipment associated with the testing environment according to a sub-configuration the new of configuration.

In an implementation form of the fourth aspect, the testing environment comprises a software testing environment and/or a hardware testing environment.

According to a fifth aspect, there is provided a computer program comprising instructions which, when the program is executed by at least one processor, cause the execution of the method of the first or second aspect.

According to a sixth aspect, there is provided a computer-readable medium comprising a computer program comprising instructions which, when the program is executed by at least one processor, cause the execution of the method of the first or second aspect.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a flow diagram of a method for evaluating a configuration associated with an elevator according to an example embodiment.

FIG. 2 illustrates a flow diagram of a method for testing a configuration associated with an elevator according to another example embodiment.

FIG. 3 illustrates an apparatus according to an example embodiment.

FIG. 4 illustrates a system according to an example embodiment.

### DETAILED DESCRIPTION

Various examples and embodiments discussed herein disclose a solution in which a new configuration for an elevator is tested such that, prior to testing the new configuration, information associated with a first testing procedure using a software package associated with an existing configuration used in the elevator is obtained. After this, the testing environment is configured according to the new configuration and a second testing procedure is performed by testing the testing environment with the software package associated with the new configuration to provide information associated with the second testing procedure. A diagnostic report is generated based on the information associated with the first testing procedure and the second testing procedure. Based on the diagnostic report and data earlier stored relating to other configurations, it is possible to generate at least one prediction associated with the new configuration.

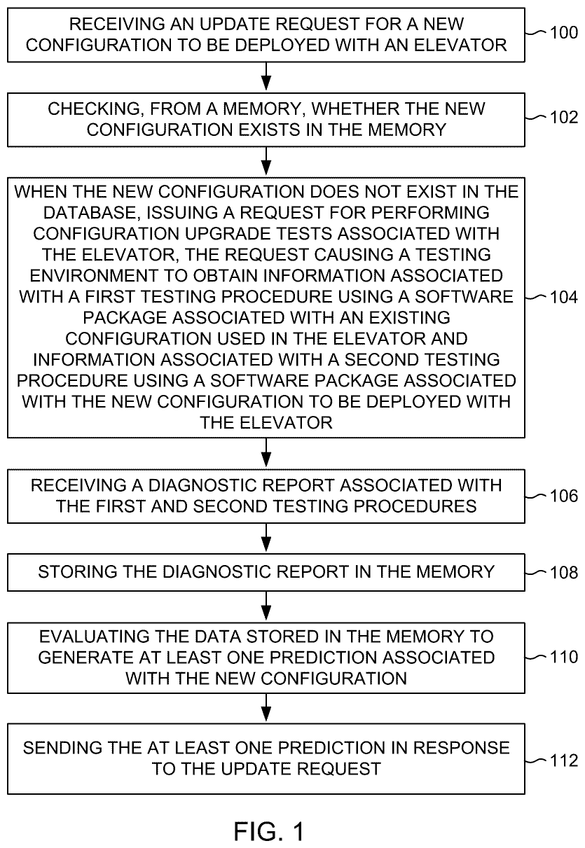

FIG. 1 illustrates a flow diagram of a method for evaluating a configuration associated with an elevator according to an example embodiment. The method may be implemented by an apparatus, for example, a cloud-based server.

At 100 an update request for a new configuration to be deployed with the elevator is received. The update request may be received, for example, from an operator preparing software upgrades to elevators.

At 102 it may be checked, from a memory, whether the new configuration exists in the memory, for example, in a database. If an identical configuration already exists in the memory, it may not be necessary to conduct any further testing, and a prediction may be returned to the operator based on the data stored in the memory.

At 104 when the new configuration does not exist in the memory, a request for performing configuration upgrade tests associated with the elevator may be issued. The request is configured to cause a testing environment to obtain information associated with a first testing procedure using a software package associated with an existing configuration used in the elevator and to obtain information associated with a second testing procedure using a software package associated with the new configuration to be deployed with the elevator.

At 106, after the testing has been performed, a diagnostic report associated with the first and second testing procedures may be received.

At 108 the diagnostic report may be stored in the memory.

At 110 the data stored in the memory may be evaluated to generate at least one prediction associated with the new configuration. In an example embodiment, machine learning may be used to provide the at least one prediction. The memory may store, for example, earlier diagnostic reports. Based on the diagnostic report received at 106 and the previously stored data, machine learning may be used to predict, for example, which noisy and/or problematic components and weight them accordingly. In an example embodiment, there can be a noisy interface which sits between components which is hard to work with, or there was a defect/issue in a specific component version, but that is temporary. Collecting data and learning from the data may help predicting the outcome of software update results. The at least one prediction may comprise, for example, a predicted success rate associated with the new configuration and/or risks associated with the new configuration.

At 112 the at least one prediction may be sent, for example, to the operator in response to the update request.

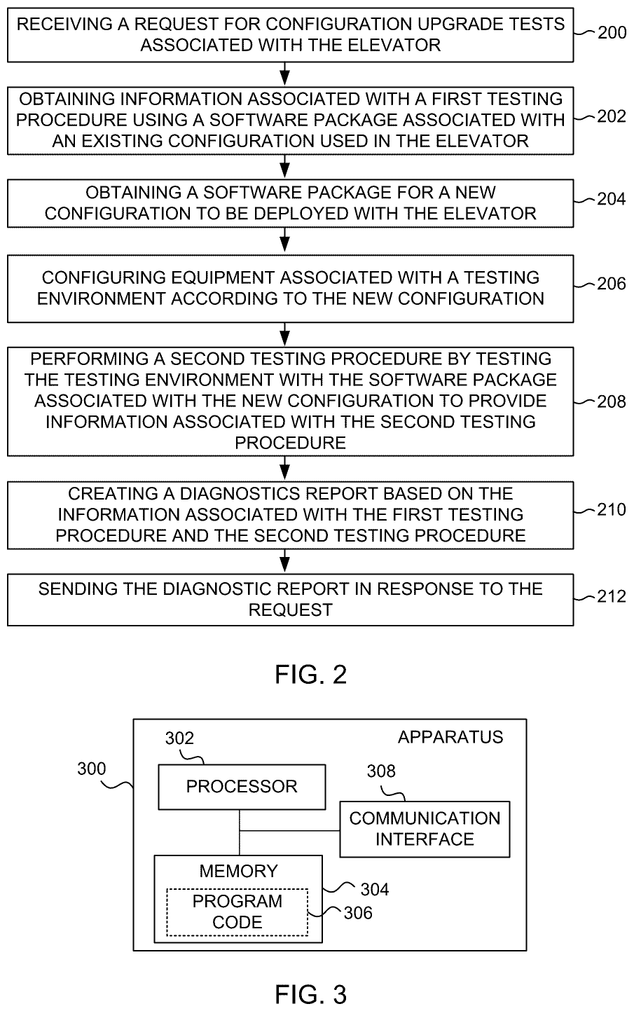

FIG. 2 illustrates a flow diagram of a method for testing a configuration associated with an elevator according to another example embodiment. The method may be performed, for example, by a testing system.

At 200 a request for configuration upgrade tests associated with the elevator may be received. The request may identify an existing configuration and a planned new configuration.

At 202 information associated with a first testing procedure using a software package associated with an existing configuration used in the elevator may be obtained. In an example embodiment, a software package for the existing configuration used with the elevator may be obtained and the equipment associated with the testing environment may be configured according to the existing configuration. The first testing procedure may be performed by testing the testing environment with the software package associated with the existing configuration to provide information associated with the first testing procedure. In other words, prior to testing the new configuration, the existing configuration may be replicated or cloned with the testing environment. A software package may include all the necessary software that is needed for cloning the existing configuration in a testing environment. In another example embodiment, instead of configuring the testing environment with the software package associated with the existing configuration, the information associated with the first testing procedure may be obtained from a memory. In other words, the first testing procedure may have been performed earlier and information about it may have been stored in the memory.

At 204 a software package for a new configuration to be deployed with the elevator may be obtained.

At 206 the equipment associated with the testing environment may be configured according to the new configuration. In an example embodiment, the existing configuration may be upgraded with the new configuration.

At 208 a second testing procedure is performed by testing the testing environment with the software package associated with the new configuration to provide information associated the with second testing procedure. When the testing environment is first configured according to the existing configuration and the upgraded with the new configuration, this emulates the situation when an actual elevator site is upgraded from an existing configuration to a new configuration and then tested on-site. Alternatively, the information associated with the first testing procedure may be obtained from a memory. In other words, the first testing procedure may have been performed earlier and information about it may have been stored in the memory.

At 210 a diagnostics report is created based on the information associated with the first testing procedure and the information associated with the second testing procedure. The diagnostic report may, for example, identify sub-tests that succeeded or failed, and provide additional information about elements or components that may not work properly in the new configuration. The diagnostic report may, for example, comprise fault log data and/or information about the update process sequence and self-test results. The diagnostic report may, for example, indicate the time it took to carry out the update and match it with the expected and still accepted intervals.

At 212 the diagnostic report is sent in response to the request to the entity, for example, a cloud-based server, which sent the request for configuration upgrade tests.

FIG. 3 illustrates an apparatus 300 according to an example embodiment. The apparatus 300 may refer, for example, to a cloud-based server or to an apparatus for configuring tests, and it may be configured to implement the method discussed above relating to FIG. 1 or FIG. 2.

The apparatus 300 comprises one or more processors 302, and one or more memories 304 that comprise computer program code. The apparatus 300 may also a communication interface 308. The communication interface 308 may provide a wired or a wireless connection to other entities, for example, via the Internet. Although the apparatus 300 is depicted to include only one processor 302, the apparatus 300 may include more than one processor. In an example embodiment, the memory 304 is capable of storing instructions, such as an operating system and/or various applications.

Furthermore, the processor 302 is capable of executing the stored instructions. In an example embodiment, the processor 302 may be embodied as a multi-core processor, a single core processor, or a combination of one or more multi-core processors and one or more single core processors. For example, the processor 302 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 302 may be configured to execute hard-coded functionality. In an example embodiment, the processor 302 is embodied as an executor of software instructions, wherein the instructions may specifically configure the processor 302 to perform the algorithms and/or operations described herein when the instructions are executed.

The memory 304 may be embodied as one or more volatile memory devices, one or more non-volatile memory devices, and/or a combination of one or more volatile memory devices and non-volatile memory devices. For example, the memory 304 may be embodied as semiconductor memories (such as mask ROM, PROM (programmable ROM), EPROM (erasable PROM), flash ROM, RAM (random access memory), etc.).

In an embodiment, the at least one memory 304 may store program instructions 306 that, when executed by the at least one processor 302, cause the apparatus 300 to perform the functionality of the various embodiments discussed herein. Further, in an embodiment, at least one of the processor 302 and the memory 304 may constitute means for implementing the discussed functionality. The apparatus 300 may be configured to receive an update request for a new configuration to be deployed with the elevator; check, from a memory, whether the new configuration exists in the memory; when the new configuration does not exist in the memory, issue a request for performing configuration upgrade tests associated with the elevator, the request causing a testing environment to obtain information associated with a first testing procedure using a software package associated with an existing configuration used in the elevator and information associated with a second testing procedure using a software package associated with the new configuration to be deployed with the elevator; receive a diagnostic report associated with the first and second testing procedures; store the diagnostic report in the memory; evaluate the data stored in the memory to generate at least one prediction associated with the new configuration; and send the at least one prediction in response to the update request, In another example embodiment, the apparatus 300 may be configured to receive a request for configuration upgrade tests associated with the elevator; obtain information associated with a first testing procedure using a software package associated with an existing configuration used in the elevator; obtain a software package for a new configuration to be deployed with the elevator; configure equipment associated with a testing environment according to the new configuration; perform a second testing procedure by testing the testing environment with the software package associated with the new configuration to provide information associated with the second testing procedure; create a diagnostics report based on the information associated with the first testing procedure and the second testing procedure; and send the diagnostic report in response to the request.

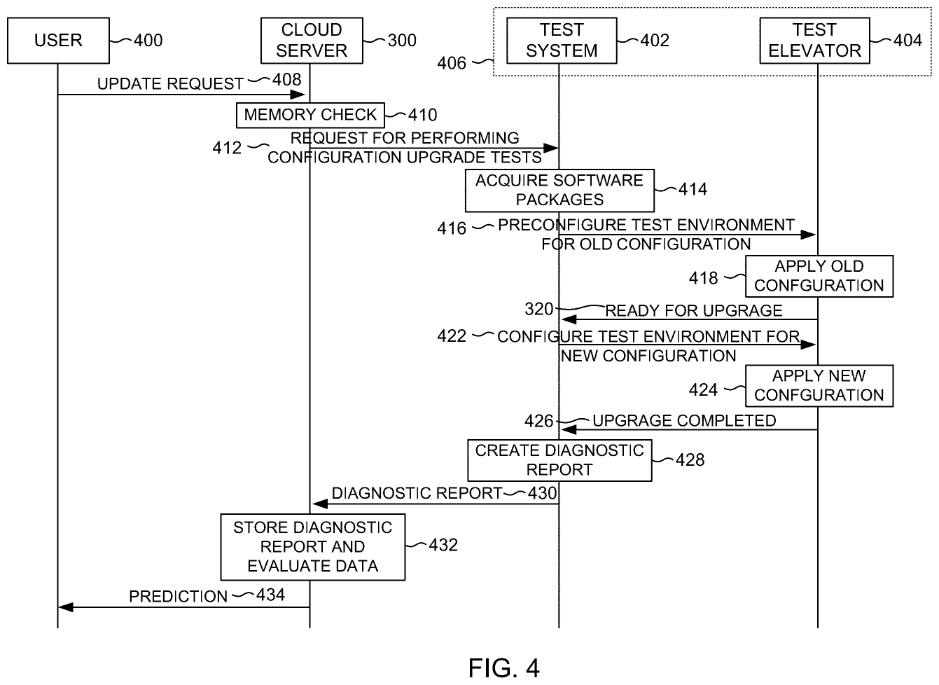

FIG. 4 illustrates a system according to an example embodiment.

At 400 a user may send an update request for a new configuration to be deployed with an elevator to a cloud server 300. The user 400 may refer, for example, to an operator preparing software upgrades to one or more elevators.

At 410 the cloud server 300 may check from a memory, for example, from a database comprising data relating to various configurations at various elevator sites, whether the new configuration already exists in the memory. If an identical configuration already exists in the memory, it may not be necessary to conduct any further testing, and a prediction may be returned to the operator based on the data stored in the memory. When the new configuration does not exist in the memory, the cloud server 300 may first suggest further testing associated with the new configuration to the operator.

In response to a confirmation from the operator, or automatically if further testing is needed, the cloud server 300 may send a request for performing configuration upgrade tests associated with the elevator to a test system 402. The request may identify an existing configuration and a planned new configuration. The request may be configured to cause a testing environment to obtain information associated with a first testing procedure using a software package associated with an existing configuration used in the elevator and to obtain information associated with a second testing procedure using a software package associated with the new configuration to be deployed with the elevator. In an example embodiment, the testing environment may refer to a software based environment that simulates a real elevator environment. In another example embodiment, the testing environment may refer to a combination of a software based environment and hardware environment, for example, a test elevator 404, or to a hardware environment only. The test system 402 and the test elevator 404 may together form a system 406 for testing the configurations.

The test system 402 may be configured to obtain software packages for the existing configuration used with the elevator and the new configuration to be deployed with the elevator. A software package may include all the necessary software that is needed for cloning the existing configuration in a testing environment. At 414 the test system 414 is configured to preconfigure the test elevator 404, i.e. the test environment, according to the existing configuration. In other words, prior to testing the new configuration, the existing configuration is replicated or cloned with the testing environment.

At 418 the existing configuration is applied and the configuration is tested. This may means, for example, that all actions needed to take the existing configuration in use are executed and a self-test is initiated. At 420 all the necessary actions have been performed and the test system is provided with an indication that the test elevator 404 is ready to be upgraded. In another example embodiment, the information associated with the first testing procedure may be obtained from a memory. In other words, the first testing procedure may have been performed earlier and information about it may have been stored in the memory and there is no need to configure the testing environment according to the existing configuration.

At 422 the test system 414 may be configured to configure the test elevator 404, i.e. the test environment, according to the new configuration. Again, all actions needed to take the new configuration in use are executed and a self-test may be initiated. This may emulate the situation when an actual elevator site is upgraded from an existing configuration to a new configuration and then tested on-site. At 426 the test system 402 may receive an indication that the upgrade is completed.

During the testing of the existing configuration (or based on the information stored in the memory about the first testing procedure) and the new configuration, the test system 402 may gather information about the overall upgrading process and the tests performed, i.e. the information associated with the first testing procedure and the second testing procedure. When the upgrade has been performed, the test system 402 may create a diagnostics report based on the information associated with the first testing procedure and the second testing procedure. The diagnostic report may, for example, identify sub-tests that succeeded or failed and/or provide additional information about elements or components that may not work properly in the new configuration.

At 430 the diagnostic report may be sent to the cloud server 300 as a response to the update request 408. At 432 the cloud server 300 may store the diagnostic report in the memory and evaluate the data stored in the memory to generate at least one prediction associated with the new configuration. In other words, the cloud server 300 may use both the diagnostic report and data already stored in the memory when determining the at least one prediction. In an example embodiment, machine learning may be used to provide the at least one prediction. For example, the at least one prediction may comprise a rate associated predicted success with the new configuration and/or risks associated with the new configuration. In an example embodiment, the diagnostic report may comprise test data associated with a sub-configuration of the existing configuration and a sub-configuration of the new configuration. For example, both the existing configuration and the new configuration may relate to an elevator of a high-rise building. When the configurations are tested, the testing environment may not enable an exactly identical confirmation. For example, the testing environment may involve only six floors while the high-rise building includes 50 floors. The cloud server 300 may then generate the at least one prediction at least in part based on the test data associated with a sub-configuration of the existing configuration and a sub-configuration of the new configuration and generalize the results to apply also for the remaining floors.

At 434 the cloud server 300 may provide the at least one prediction to the user 400. Based on the at least one prediction, the user may make the final decision whether to perform the upgrade to an actual elevator.

At least one of the examples and embodiments disclosed above may provide a solution that may enable more frequent and/or quicker software updates to elevators. For example, if a requested configuration already exists in the database, the cloud server may determine without any additional tests that the software can be updated. And when new configurations are tested, data obtained relating them may be used by the cloud server in generating subsequent configuration predictions. Further, at least one of the examples and embodiments disclosed above may provide a solution that may enable determining whether new features relating to a new software release can be applied in older elevator installations. Further, at least one of the examples and embodiments disclosed above may provide a solution that may enable developers to learn about design, component and/or interface weaknesses and improve them.

Example embodiments may be implemented in software, hardware, application logic or a combination of software, hardware and application logic. The example embodiments can store information relating to various methods described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A method for evaluating a configuration associated with an elevator, the method comprising:
receiving an update request for a new configuration to be deployed with the elevator;
checking, from a memory, whether the new configuration exists in the memory;
when the new configuration does not exist in the memory, issuing a request for performing configuration upgrade tests associated with the elevator, the request causing a testing environment to obtain information associated with a first testing procedure using a software package associated with an existing configuration used in the elevator and information associated with a second testing procedure using a software package associated with the new configuration to be deployed with the elevator;
receiving a diagnostic report associated with the first and second testing procedures;
storing the diagnostic report in the memory;
evaluating the data stored in the memory to generate at least one prediction associated with the new configuration; and
sending the at least one prediction in response to the update request.

2. The method of claim 1, further comprising:
evaluating the data stored in the memory to generate the at least one prediction associated with the new configuration by applying machine learning.

3. The method of claim 1, wherein the at least one prediction comprises at least one of a predicted success rate associated with the new configuration and risks associated with the new configuration.

4. The method of claim 1, wherein the diagnostic report comprises test data associated with a sub-configuration of the existing configuration and a sub-configuration of the new configuration, and the method further comprises:
generating the at least one prediction at least in part based on the test data associated with a sub-configuration of the existing configuration and a sub-configuration of the new configuration.

5. The method of claim 1, wherein the testing environment comprises a software testing environment and/or a hardware testing environment.

6. A method for testing a configuration associated with an elevator, the method comprising:
receiving a request for configuration upgrade tests associated with the elevator;
obtaining information associated with a first testing procedure using a software package associated with an existing configuration used in the elevator;
obtaining a software package for a new configuration to be deployed with the elevator;
configuring equipment associated with a testing environment according to the new configuration;
performing a second testing procedure by testing the testing environment with the software package associated with the new configuration to provide information associated with the second testing procedure;
creating a diagnostics report based on the information associated with the first testing procedure and the second testing procedure; and
sending the diagnostic report in response to the request.

7. The method of claim 6, wherein obtaining information associated with a first testing procedure using a software package associated with an existing configuration used in the elevator comprises:
obtaining a software package for the existing configuration used with the elevator;
configuring the equipment associated with the testing environment according to the existing configuration; and
performing the first testing procedure by testing the testing environment with the software package associated with the existing configuration to provide information associated with the first testing procedure.

8. The method of claim 6, wherein obtaining information associated with a first testing procedure using a software package associated with an existing configuration used in the elevator comprises:
obtaining the information associated with the first testing procedure from a memory.

9. The method of claim 6, wherein configuring equipment associated with a testing environment according to the existing configuration comprises configuring the equipment associated with the testing environment according to a sub-configuration of the existing configuration.

10. The method of claim 6, wherein configuring equipment associated with a testing environment according to the new configuration comprises configuring the equipment associated with the testing environment according to a sub-configuration of the new configuration.

11. The method of claim 6, wherein the testing environment comprises a software testing environment and/or a hardware testing environment.

12. An apparatus for evaluating a configuration associated with an elevator, the apparatus comprising:
means for receiving an update request for a new configuration to be deployed with the elevator;
means for checking, from a memory, whether the new configuration exists in the memory;
means for issuing a request for performing configuration upgrade tests associated with the elevator, when the new configuration does not exist in the memory, the request causing a testing environment to obtain information associated with a first testing procedure using a software package associated with an existing configuration used in the elevator and information associated with a second testing procedure using a software package associated with the new configuration to be deployed with the elevator;
means for receiving a diagnostic report associated with the first and second testing procedures;
means for storing the diagnostic report;
means for evaluating the stored data to generate at least one prediction associated with the new configuration; and
means for sending the at least one prediction in response to the update request.

13. The apparatus of claim 12, further comprising:
means for evaluating the data stored in the memory to generate the at least one prediction associated with the new configuration by applying machine learning.

14. The apparatus of claim 12, wherein the at least one prediction comprises at least one of a predicted success rate associated with the new configuration and risks associated with the new configuration.

15. The apparatus of claim 12, wherein the diagnostic report comprises test data associated with a sub-configuration of the existing configuration and a sub-configuration of the new configuration, and the apparatus further comprises:
means for generating the at least one prediction at least in part based on the test data associated with a sub-configuration of the existing configuration and a sub-configuration of the new configuration.

16. The apparatus of claim 12, wherein the testing environment comprises a software testing environment and/or a hardware testing environment.

17. A system for testing a configuration associated with an elevator, the system comprising:
means for receiving a request for configuration upgrade tests associated with the elevator;
means for obtaining information associated with a first testing procedure using a software package associated with an existing configuration used in the elevator;
means for obtaining a software package for a new configuration to be deployed with the elevator;
means for configuring equipment associated with a testing environment according to the new configuration;
means for performing a second testing procedure by testing the testing environment with the software package associated with the new configuration to provide information associated with the second testing procedure;
means for creating a diagnostics report based on the information associated with the first testing procedure and the second testing procedure; and
means for sending the diagnostic report in response to the request.

18. The system of claim 17, wherein the means for obtaining information associated with a first testing procedure using a software package associated with an existing configuration used in the elevator are configured to:
obtain a software package for the existing configuration used with the elevator;
configure the equipment associated with the testing environment according to the existing configuration; and
perform the first testing procedure by testing the testing environment with the software package associated with the existing configuration to provide information associated with the first testing procedure.

19. The system of claim 17, wherein the means for obtaining information associated with a first testing procedure using a software package associated with an existing configuration used in the elevator are configured to obtain the information associated with the first testing procedure from a memory.

20. The system of claim 17, wherein the means for configuring are configured to configure the equipment associated with the testing environment according to a sub-configuration of the existing configuration.

21. The system of claim 17, wherein the means for configuring are configured to configure the equipment associated with the testing environment according to a sub-configuration of the new configuration.

22. The system of claim 17, wherein the testing environment comprises a software testing environment and/or a hardware testing environment.

23. A non-transitory computer readable medium storing a computer program comprising instructions which, when the program is executed by at least one processor, cause the execution of the method of claim 1.

24. A non-transitory computer-readable medium comprising a computer program comprising instructions which, when the program is executed by at least one processor, cause the execution of the method of claim 5.
